(19) United States
(12) Patent Application Publication
(10) Pub. No.: US 2010/0316789 A1
(43) Pub. Date: Dec. 16, 2010

(54) METHOD OF MODIFYING SILICA NANOPOWDER SURFACES

(75) Inventors: Hee Dong Jang, Daejeon (KR); Han Kwon Chang, Daejeon (KR); Dae Sub Kil, Daejeon (KR); Kuk Cho, Daejeon (KR)

Correspondence Address: Yoo & Associates, Inc., 5212 S. Miller Pl., Chandler, AZ, 85249, US

(73) Assignee: Korea Institute of Geoscience and Mineral Resources

(21) Appl. No.: 12/575,505

(22) Filed: Oct. 8, 2009

(30) Foreign Application Priority Data
Jun. 10, 2009 (KR) 10-2009-0051578

(51) Int. Cl. B05D 7/00

(52) U.S. Cl. 427/8; 427/213.31

(57) ABSTRACT

In accordance with one embodiment, a method of modifying the surface of silica nanopowder by a spray heating process is provided. In the method, surface characteristics of silica nanopowder are modified from hydrophilic to hydrophobic. A colloidal suspension including silica nanopowder and a surface modifier which are dissolved in ethanol is sprayed and thermally dried so that the surface characteristics of silica nanopowder are modified by the surface modifier coated on the surface of silica nanopowder. In the method, silica nanopowder surfaces are modified from hydrophilic to hydrophobic by controlling concentration and type of a surface modifier and heating temperature.

### CROSS-REFERENCE TO RELATED APPLICATION

This application claims priority to and the benefit of Korean Patent Application No. 10-2009-0051578, filed on Jun. 10, 2009, which is herein incorporated by reference in its entirety.

### BACKGROUND OF THE INVENTION

1. Field of the Invention

The present application relates to methods of modifying silica nanopowder surfaces and more particularly, to methods of modifying silica nanopowder surfaces from hydrophilicity to hydrophobicity.

2. Description of the Related Art

Silica nanopowder is a functional industry raw material used as an additive and filler in fine chemical industries, and controls the dispersivity and viscosity of a solution. Silica nanopowder has hydrophilic surfaces which absorbs moisture from the air so that cohesion between particles and reduction of fluidity are observed. Such hydrophilic surface characteristics cause quality deterioration when hydrophilic silica nanopowder is added to polymeric materials or a solvent.

Therefore, surface modification of silica nanopowder improves the function of silica nanopowder as an additive, and the silica nanopowder having modified surface may be widely used in various industrial fields.

To modify surface characteristics of silica nanopowder from hydrophilicity to hydrophobicity, a method is required to attach a surface modifier that has hydrophobic functional groups on silica nanopowder surfaces. Accordingly, various kinds of surface modifiers are used for the method and various treatment processes have been studied.

### SUMMARY OF THE INVENTION

The present invention provides a method of modifying silica nanopowder surfaces to make a continuous production possible, and to reduce total manufacturing process time for recovering hydrophobically modified silica nanopowder.

In accordance with one embodiment, a method of modifying silica nanopowder surfaces includes: preparing a silica suspension solution by mixing silica nanopowder and a surface modifier in ethanol, spraying the silica suspension solution to make fine particles, and thermally drying the spray droplets of the silica suspension to prepare hydrophobic surface-modified silica nanopowder.

The method may further include collecting and recovering silica nanopowder, and evaluating physical properties, such as wettability of the silica nanopowder, to evaluate the surface-modified silica nanopowder, which is carried out after the collection and recovery.

The amount of the surface modifier used is approximately 5 to 40 wt % for every 100 wt % of the silica nanopowder.

The surface modifier may further include at least one of compounds selected from the group consisting of stearic acid, trimethylchlorosilane, and octadecylchlorosilane.

The thermally drying temperature of the spray droplets solution may be from approximately 100 to 400 degrees Celsius.

The size of the silica nanopowder can be used from approximately 10 to 100 nm.

According to the method of the present invention, the hydrophobicity of the silica nanopowder can be controlled by adjusting concentration of a surface modifier and spray heating temperature.

Moreover, the method of the present invention can be carried out in an integral process of recovering the surface modifier coated particles prepared by spray heating process in which a silica-modifier-ethanol suspension is sprayed and heated to evaporate ethanol. Using this method, operating hours can be shortened to within one minute and therefore continuous operation can be enabled.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a process flowchart illustrating modification of silica nanopowder surfaces according to an embodiment of the present invention;

FIG. 2 is a graph illustrating wettability of the surface-modified silica nanopowder according to concentration changes of stearic acid;

FIG. 3 is an electron microscopic picture of surface-modified silica nanopowder by using 2.0% by weight of stearic acid;

FIG. 4 is Fourier transform infrared (FT-IR) spectra of surface-modified silica nanopowder by respectively using 0.25, 1.00, and 2.00 wt % of stearic acid;

FIG. 5 is a graph illustrating wettability of the surface-modified silica nanopowder by stearic acid and using a two-fluid nozzle;

FIG. 6 is a graph illustrating wettability of the surface-modified silica nanopowder by trimethylchlorosilane and using a two-fluid nozzle;

FIG. 7 is a graph illustrating wettability of the surface-modified silica nanopowder by octadecylchlorosilane and using a two-fluid nozzle; and

FIG. 8 is a Fourier transform infrared spectra of surface-modified silica nanopowder by stearic acid at 200, 300, and 500 degree Celsius respectively, using an ultrasonic sprayer.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, an integral process of modifying surface characteristics of silica nanopowder, including: preparing a mixed suspension, spraying, drying, and recovering particles, will be described in detail with accompanying drawings containing analyzed results.

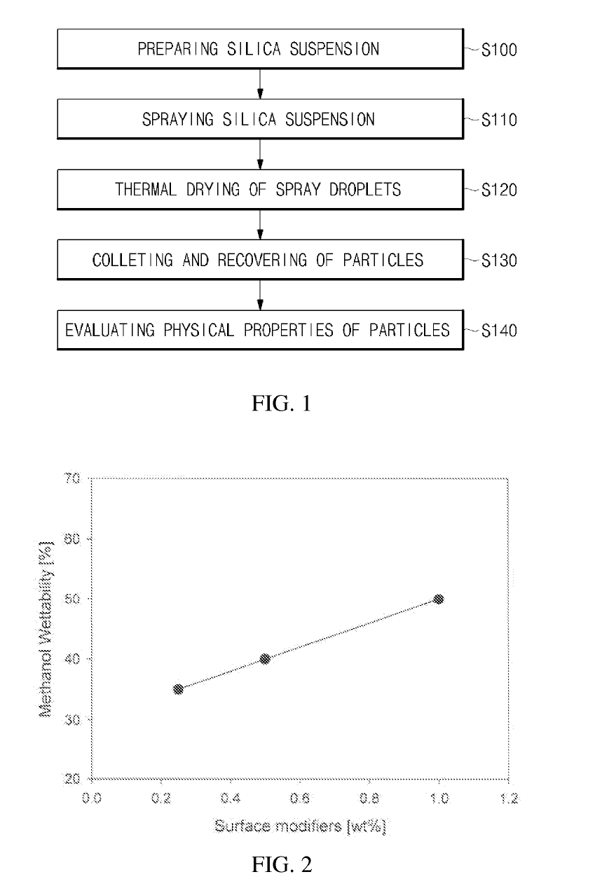

In accordance with one embodiment, a method of modifying silica nanopowder surfaces will be described. FIG. 1 is a process flowchart illustrating a method of modifying silica nanopowder surfaces according to an embodiment of the present invention.

The method of modifying silica nanopowder surfaces according to the embodiment of the present invention is carried out by preparing a silica suspension operation S100, spraying the silica suspension operation S110, and thermally drying of the spray droplets operation S120. The method may further include steps of collecting and recovering of particles operation S130, and evaluating physical properties of particles operation S140.

According to the method of modifying silica nanopowder surfaces, a certain amount of silica nanopowder, a surface modifier, and ethanol are mixed to prepare a silica-surface modifier-ethanol suspension. The suspension is sprayed and heated to form spray droplets of the suspension and to evaporate the ethanol so that the surface modifiers are coated on the surfaces of silica nanopowder. The dried particles are recovered by the particle collectors. Further, evaluation of physical properties of the modified silica nanopowder, such as hydrophobicity, particle shape, and surface characteristics, are carried out in the method of modifying silica nanopowder surfaces.

In preparing the silica suspension operation S100, the silica suspension is prepared by mixing silica nanopowder and a surface modifier in ethanol. From approximately 5 to 40 wt % of the surface modifier is used for every 100 wt % of silica nanopowder. When the amount of the modifier is too small, surface modification of silica nanopowder is not satisfactory, while when the amount of the modifier is too large, the excessive surface modifiers result in severe coagulation of particles.

The amount of ethanol is determined for appropriate spray of the silica suspension according to the amount of the silica nanopowder and the surface modifier. In this embodiment, the amount of ethanol is approximately 90 to 95 wt % for the total amount of the silica suspension.

The size of the silica nanopowder is approximately from 10 to 100 nm. In a preferred embodiment, silica nanopowder of approximately 10 to 50 nm may be used.

When the size of the silica nanopowder is too small, the particles are lumped together so that homogeneous suspension is difficult. On the contrary, when the size of the silica nanopowder is too large, it is difficult to prepare a homogeneous suspension, and nozzles of a droplet generator may be blocked by the silica nanopowder, resulting in unstable work.

At least one compound selected from the group consisting of stearic acid, trimethylchlorosilane, and octadecylchlorosilane is used as the surface modifier. The type and amount of a surface modifier may control hydrophobicity of silica particles. It should be noted that the listing of the above materials should not be seen as to limit the scope of the present invention. Other materials may be used without departing from the spirit and scope of the present invention.

In spraying the silica suspension operation S110, the silica suspension is sprayed to form fine spray droplets. The silica suspension is sprayed by an apparatus such as an ultrasonic droplet generator, a two-fluid nozzle, or its equivalents. These apparatuses are generally used in the art and their detailed description will be omitted.

In thermally drying of spray droplets operation S120, the spray droplets of the silica suspension are dried at approximately 100 to 400 degrees Celsius to prepare surface-modified silica nanopowder having hydrophobicity. The spray droplets of the silica suspension may be introduced to a region of approximately 100 to 400 degrees Celsius by using a carrier gas such as air, nitrogen, or argon. However, other types of gas may be used without departing from the spirit and scope of the present invention. The temperature of approximately 100 to 400 degrees Celsius may be obtained by using an electric furnace or a heat treatment furnace. In other words, the spray droplets of the silica suspension are transported to an electric furnace by a carrier gas and thermally dried therein.

When ethanol is evaporated during the thermally drying, the spray droplets of the silica suspension become surface-modified silica nanopowder on which the surface modifiers are coated. Accordingly, the surface-modified silica nanopowder has hydrophobicity due to the coating of the surface modifier.

In collecting and recovering of particles operation S130, the surface-modified particles are collected and recovered. The surface-modified silica nanopowder is heated and dried. Then, it is transported by the carrier gas to an apparatus including a cyclone and a bag filter, where it will be collected and recovered. Various particle-collecting apparatuses may be used for the collecting and recovering of the surface-modified silica nanopowder.

In evaluating physical properties of particles operation S140, physical properties of the surface-modified silica nanopowder are evaluated. The physical properties are analyzed by several methods, such as wettability analysis using methanol to measure hydrophobicity of the surface-modified silica nanopowder, particle shape analysis using a scanning electron microscope (SEM), and analysis of particle surface properties using a Fourier transform infrared (FT-IR) spectrophotometer. However, other types of analysis may be evaluated. Since the above-mentioned analyses are widely used in the analysis of particle surface properties, the detailed description of the analyses will be omitted.

Hereinafter, the method of modifying silica nanopowder surfaces according to the embodiment of the present invention will be described in detail.

### Example 1

In Example 1, 0.25, 0.5, or 1.0 wt % of stearic acid as a surface modifier and 5 wt % of silica nanopowder were respectively used to prepare a silica suspension, and the remainder of ethanol is added.

Spray droplets were generated from the silica suspension by an ultrasonic sprayer, and then the fine spray droplets were migrated by air as a carrier (1 L/min) to a circular electric furnace, the maximum temperature of which was maintained at approximately 250 degrees Celsius, and the fine spray droplets were dried therein. In the electric furnace, ethanol was removed from spray droplets of the silica suspension so that the surface-modified silica nanopowder, on which stearic acid was coated, was prepared.

Hydrophobicity of the surface-modified silica nanopowder was determined by the following methanol wettability measurement.

50 ml of distilled water was put into a beaker, 0.2 g of surface-modified particles to be measured was put into the distilled water, and a small amount of methanol was gradually added with stirring. When a preset amount of methanol was added, precipitation began. When all of the suspended surface-modified particles were immersed in the water, the volume of methanol was measured to calculate wettability. The hydrophobicity of the particles in terms of methanol wettability was calculated by the following equation:

Wettability=a/(50+a)×100 (a: added amount of methanol).

FIG. 2 shows the wettability of the surface-modified silica nanopowder by stearic acid. As the amount of stearic acid increased from 0.25 to 1.0 wt %, it was understood that the wettability of the surface-modified silica nanopowder increased from 35 to 50%.

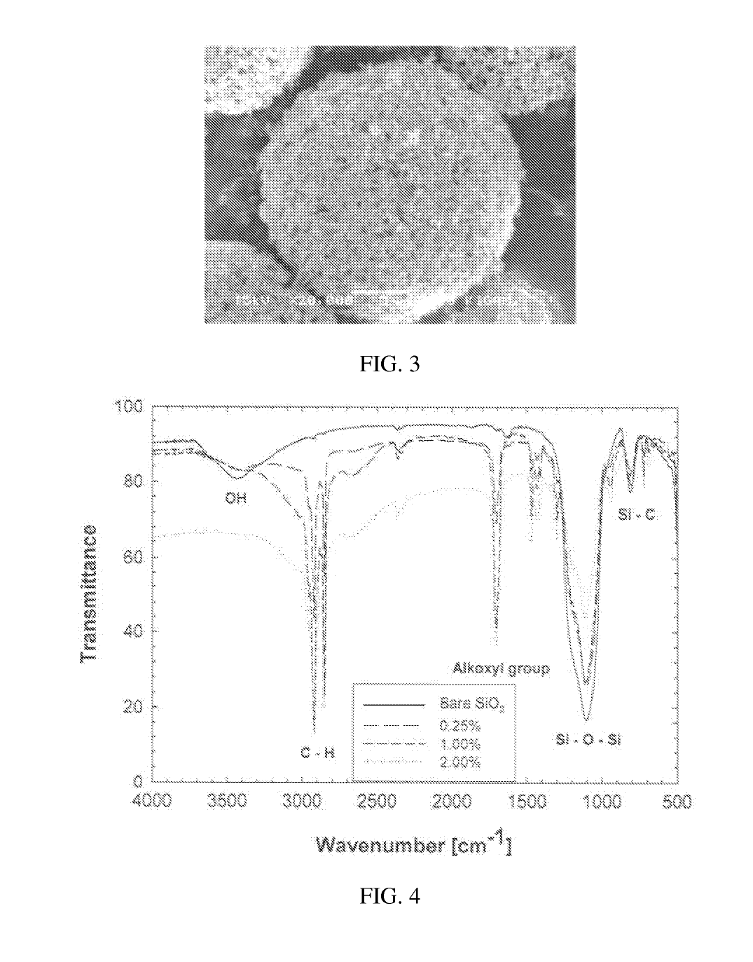

FIG. 3 shows an electron microscopic picture of the surface-modified silica nanopowder by 1.0 wt of stearic acid. From FIG. 3, it was understood that the silica particles were self-assembled in the spray droplets during the thermally drying.

FIG. 4 shows FT-IR spectra of the surface-modified silica nanopowder by stearic acid, in which alkoxyl functional groups are attached to the surfaces of the particles.

### Example 2

In Example 2, a surface modification was carried out by using a two-fluid nozzle to generate spray droplets of the same suspension as that used in Example 1. The two-fluid nozzle can generate more spray droplets than those generated by an ultrasonic droplet generator so that mass production of spray droplets is enabled.

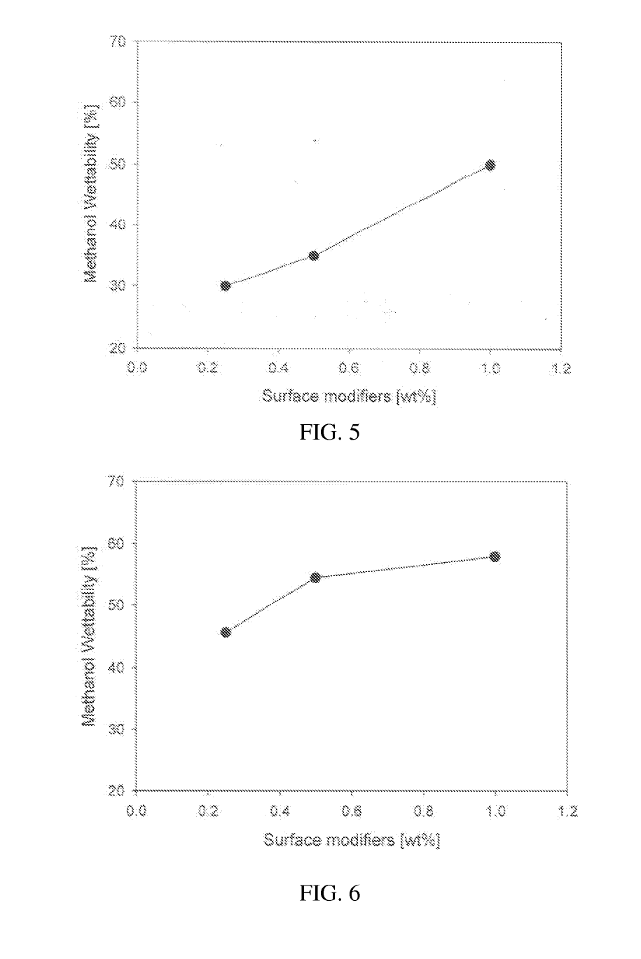

FIG. 5 shows wettability of the surface-modified silica nanopowder by stearic acid and by the two-fluid nozzle. As the amount of stearic acid increased from 0.25 to 1.0 wt %, wettability of the surface-modified silica nanopowder increased from 30 to 50%.

### Example 3

In Example 3, a surface modification was carried out by using trimethylchlorosilane instead of the stearic acid used in Example 2, but under the same experimental conditions as those in Example 2.

FIG. 6 shows wettability of the surface-modified silica nanopowder by trimethylchlorosilane and by using a two-fluid nozzle. As the amount of stearic acid increased to 0.25, 0.5 to 1.0 wt % step-by-step, wettability of the surface-modified silica nanopowder increased to 45, 54, and 58%, respectively.

### Example 4

In Example 4, a surface modification was carried out by using octadecylchlorosilane instead of the stearic acid used in Example 2, but under the same experimental conditions as those in Example 2.

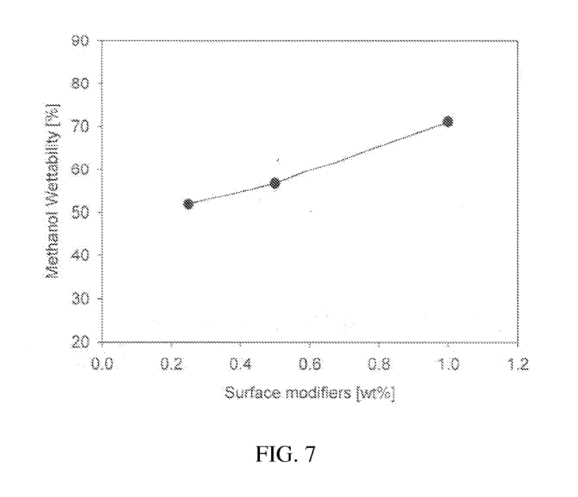

FIG. 7 shows wettability of the surface-modified silica nanopowder by octadecylchlorosilane and by using a two-fluid nozzle. As the amount of octadecylchlorosilane increased to 0.25, 0.5, and 1.0 wt %, wettability of the surface-modified silica nanopowder increased to 52, 57, and 71%, respectively.

### Example 5

In Example 5, surface modification was carried out by changing thermally drying temperatures in spray drying, but under the same conditions as those in Example 1. Thermally drying temperatures were 200 and 300 degrees Celsius, which were compared with a temperature of 500 degrees Celsius.

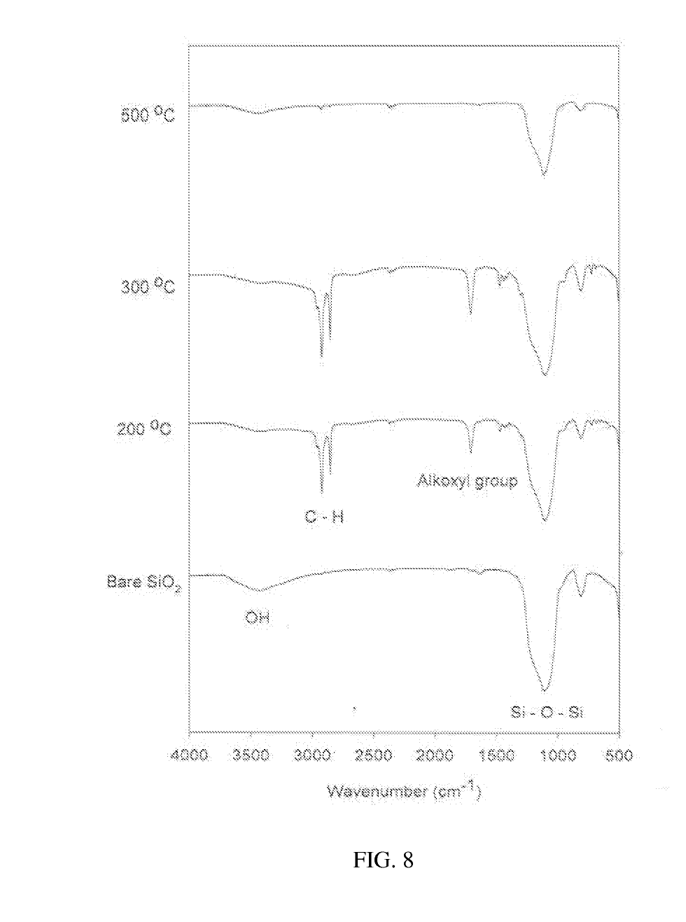

FIG. 8 shows FT-IR spectra of the surface-modified silica nanopowder according to thermally drying temperature changes. Alkoxyl functional groups are detected from the surface of the particles when drying temperature was 200 and 300 degrees Celsius, but not detected from the surface of the particles when drying temperature was 500 degrees Celsius. Therefore, it is understood that surface modifiers do not exist at approximately 500 degrees Celsius.

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

The research was carried out as one of projects regarding technologies for the synthesis of nano-materials precursors from mineral resources, which is supported by Ministry of Knowledge and Economy of Republic of Korea (Project Number: GP2006-003).

What is claimed is:

1. A method of modifying silica nanopowder surfaces comprising;
preparing a silica suspension solution by mixing silica nanopowder and a surface modifier in ethanol;
spraying the silica suspension solution to make fine spray droplets; and
thermally drying the spray droplets of the silica suspension to prepare hydrophobic surface-modified silica nanopowder.

2. The method of claim 1, further comprising:
collecting and recovering the surface-modified silica nanopowder; and
evaluating physical properties of the surface-modified silica nanopowder,
wherein the collecting and recovering and the evaluating are carried out after the thermally drying.

3. The method of claim 1, wherein the amount of the surface modifier used is approximately 5 to 40 wt % for every 100 wt % of the silica nanopowder.

4. The method of claim 1, wherein the surface modifier is selected from the group consisting of stearic acid, trimethylchlorosilane, and octadecylchlorosilane.

5. The method of claim 1, wherein the thermally drying temperature of the spray droplets is approximately 100 to 400 degrees Celsius.

6. The method of claim 1, wherein the silica nanopowder has a size of approximately 10 to 100 nm.

7. The method of claim 1, wherein the spraying the silica suspension solution is conducted by an apparatus and the apparatus is selected from the group consisting of an ultrasonic droplet generator and a two-fluid nozzle.

8. A method of modifying silica nanopowder surfaces comprising;
preparing a silica suspension solution by mixing silica nanopowder and a surface modifier in ethanol, wherein the amount of the ethanol is approximately 90 to 95 wt % of the silica suspension solution;
spraying the silica suspension solution to make spray droplets; and
thermally drying the spray droplets of the silica suspension to prepare surface-modified silica nanopowder.

9. The method of claim 8, further comprising:
collecting and recovering the surface-modified silica nanopowder; and
evaluating physical properties of the surface-modified silica nanopowder.

10. The method of claim 8, wherein the amount of the surface modifier used is approximately 5 to 40 wt % for every 100 wt % of the silica nanopowder.

11. The method of claim 8, wherein the surface modifier is selected from the group consisting of stearic acid, trimethylchlorosilane, and octadecylchlorosilane.

12. The method of claim 8, wherein the thermal drying temperature of the spray droplets is approximately 100 to 400 degrees Celsius.

13. The method of claim 8, wherein the silica nanopowder has a size of approximately 10 to 100 nm.

14. The method of claim 8, wherein the spraying the silica suspension solution is conducted by an apparatus and the apparatus is selected from the group consisting of an ultrasonic droplet generator and a two-fluid nozzle.

15. A method of modifying silica nanopowder surfaces comprising;
preparing a silica suspension solution by mixing silica nanopowder and a surface modifier in ethanol;
spraying the silica suspension solution to make spray droplets;
thermally drying the spray droplets of the silica suspension to prepare surface-modified silica nanopowder, wherein the thermally drying is conducted at the temperature of approximately 100 to 400 degrees Celsius;
collecting and recovering the surface-modified silica nanopowder, wherein the surface-modified silica nanopowder transported to an apparatus by a carrier gas to be collected and recovered; and
evaluating physical properties of the surface-modified silica nanopowder.

16. The method of claim 15, wherein the amount of the ethanol is approximately 90 to 95 wt % of the silica suspension solution.

17. The method of claim 15, wherein the amount of the surface modifier used is approximately 5 to 40 wt % for every 100 wt % of the silica nanopowder.

18. The method of claim 15, wherein the surface modifier is selected from the group consisting of stearic acid, trimethylchlorosilane, and octadecylchlorosilane.

19. The method of claim 15, wherein the silica nanopowder has a size of approximately 10 to 100 nm.

20. The method of claim 15, wherein the spraying the silica suspension solution is conducted by an apparatus and the apparatus is selected from the group consisting of an ultrasonic droplet generator and a two-fluid nozzle.
